(19) United States
(12) Patent Application Publication
(10) Pub. No.: US 2006/0099061 A1
(43) Pub. Date: May 11, 2006

(54) Ramp for truck and trailers for automotive and equipment delivery

(75) Inventors: Raymond Smith JR., Lake Bluff, IL (US); Joseph Simons, Oconomowoc, WI (US); Philip Simons, Oconomowoc, WI (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: Up-N-Atom, Inc.

(21) Appl. No.: 11/220,150

(22) Filed: Sep. 6, 2005

Related U.S. Application Data
(60) Provisional application No. 60/608,502, filed on Sep. 9, 2004.
(60) Provisional application No. 60/698,431, filed on Jul. 12, 2005.

(51) Int. Cl. B60P 1/00

(52) U.S. Cl. 414/537

(57) ABSTRACT

A folding ramp system to be deployed under power for a truck, truck bed or trailer is disclosed.

This application claims the priority benefit of prior provisional applications 60/608,502 filed Sep. 9, 2004 and 60/698,431 filed Jul. 12, 2005.

### BACKGROUND OF THE INVENTION

The present invention relates to ramps for trucks, truck beds, or trailers. Such ramps are especially beneficial for automobile and equipment delivery.

Distributors of construction related rental equipment are daily confronted with the task of reducing the cost of single unit equipment delivery to the end user. Many are forced to use large tractors and trailers or heavy duty trucks equipped with roll back beds, which have been purchased to haul the bulkiest equipment in their rental fleets, for delivery of very small units. This has made the single delivery of a small unit very costly to the distributor since he cannot pass on the full expense to his customer. To reduce costs, the distributor will sometimes load a large trailer with a number of pieces of equipment, each destined for delivery to a different site. By following this practice, only one customer will receive his order in a timely fashion. The rest will have to wait.

An alternative method requires that the distributor own one or several small trailers towed by heavy duty pick-up trucks to make these deliveries. Even a small truck-trailer combination is quite long and difficult to maneuver for all but a skilled operator, especially in crowded city traffic. Delivery on muddy construction sites with such truck-trailer combinations is extremely difficult, especially when backing up to a drop off site is required.

Applicants designed a truck bed which overcomes these shortcomings. That truck bed is described in U.S. Pat. No. 6,698,996 issued Mar. 2, 2004 and U.S. application Ser. No. 10/751,177 filed Jan. 2, 2004, each of which is incorporated herein by reference. As explained below, Applicants have designed a new, full width, power deployed ramp system as an option to a manually deployed ramp system so as to eliminate any manual effort by the operator to lower or raise the ramp.

### SUMMARY OF THE INVENTION

The present invention is directed to full width folding ramp system which can be deployed under power and can be attached to and used with a truck, truck bed, or trailer.

A first embodiment of the present invention is directed to a ramp system connected to a base comprising a first ramp section; a second ramp section having a front end and a back end, said front end being connected to said first section; and a slide mechanism connected to said base and said back end of said second ramp section, said slide mechanism being extendable from and retractable into said base, wherein in a folded configuration, said first ramp section is positioned substantially vertically and adjacent to said base, said second ramp section is positioned substantially vertically and adjacent to said base and almost all of said slide mechanism is located within said base, wherein as said slide mechanism extends from said base, said back end of said second ramp section begins to separate from said first ramp section, and said first and second ramp sections begin to move to a substantially horizontal position, and wherein when said slide mechanism is completely extended from said base, said first and second ramps are in a substantially horizontal position.

Additionally, the ramp system of the first embodiment can include a third ramp section connected to said back end of said second ramp section.

A second embodiment of the present invention is directed to a ramp system connected to a base comprising a ramp section having a front end and a back end, said front end being connected to said base; a ramp column comprising a column slide connected to said base; a column sleeve connected to said back end of said ramp section; and a spring connected to said column slide and said column sleeve; and a cylinder connected to said base and said front end of said ramp section, said cylinder being extendable from and retractable into said base, wherein in a folded configuration, said ramp section is positioned substantially vertically and said cylinder is fully extended from said base, wherein as said cylinder retracts into said base, said ramp section begins to rotate toward a horizontal position, said column slide retracts into said column sleeve shortening said ramp column and compressing said spring, until said ramp column is fully retracted and said ramp section is in a substantially horizontal position.

Additionally, the ramp system of the second embedment can include a second ramp section having a front end and a back end, said front end of said second ramp section being connected to said back end of said ramp section; wherein in a folded configuration, said second ramp section is positioned substantially vertically, forward of and adjacent to said ramp section, wherein as said cylinder retracts into said base and said ramp section begins to rotate toward a horizontal position, said second ramp section also moves toward a horizontal position, until said ramp section and said second ramp section are in a substantially horizontal position, with said second ramp section on top of said ramp section.

In another embodiment, the ramp system of the present invention is used with the truck bed of the '996 patent or '177 application.

In another embodiment of the present invention, the ramp system can be attached to a trailer, or to a flat bed truck.

### BRIEF DESCRIPTION OF THE DRAWINGS

In describing the preferred embodiments, reference is made to the accompanying drawings wherein:

FIGS. 1A-1B show an unloaded truck and the truck bed with a first embodiment of the ramp system of the present invention in the travel position.

FIGS. 2A-2B show an unloaded truck and truck bed with the truck's air suspension lowered and the first embodiment of the ramp system of the present invention in the travel position.

FIGS. 3A-3B show the truck, truck bed and ramp of FIGS. 2A-2B with the ramp beginning to unfold.

FIGS. 4A-4B show the truck, truck bed and ramp of FIGS. 3A-3B with the first section and second section unfolded in the travel position.

FIGS. 5A-5B show the truck, truck bed and ramp of FIGS. 4A-4B with the first section, second section and third section unfolded in the travel position.

FIGS. 6A-6B show the truck, truck bed and ramp of FIGS. 5A-5B with the first section, second section and third section unfolded and the rear portion of the truck bed in the lowered load/unload position.

FIG. 7 shows a sectional view of a second embodiment of the present invention with a two section ramp in the traveling position, wherein the first or ramp front section is attached to the rear portion of the truck bed at a hinge point and the second or ramp approach section is shown folded over ramp front section around a second hinge pin.

FIG. 8 shows a sectional view of the ramp of FIG. 7 partially lowered with the truck bed in the travel position.

FIG. 9 shows a sectional view of the ramp of FIG. 8 with the first section fully supported in its lowered position by a ramp column with the truck bed in the travel position.

FIG. 10 shows a side view of the ramp of FIG. 9 with the first section fully lowered with the truck bed in the travel position.

FIG. 11 shows a side view of the ramp of FIG. 10 wherein the second section is shown in various stages of unfolding around the second hinge pin with the truck bed in the travel position.

FIG. 12 shows a side view of two section ramp of FIG. 11 of the second embodiment of the present invention fully deployed with the truck bed in the travel position with rear portion of the truck bed ready to be lowered to the ground for loading or unloading.

### DETAILED DESCRIPTION OF THE PRESENTLY PREFERRED EMBODIMENTS

The accompanying drawings show an unloaded truck 10 with a truck frame 11 and a truck bed 12. The truck bed 12 has a front portion 14 and a rear portion 16. While the preferred embodiment herein has a front portion 14 and a rear portion 16, with each constructed in the form of an arch, as shown in the figures, one skilled in the art will appreciate that the ramp of the present invention can be used on truck beds or trailers of various sizes and configurations, including ones that have only one deck portion and/or are flat.

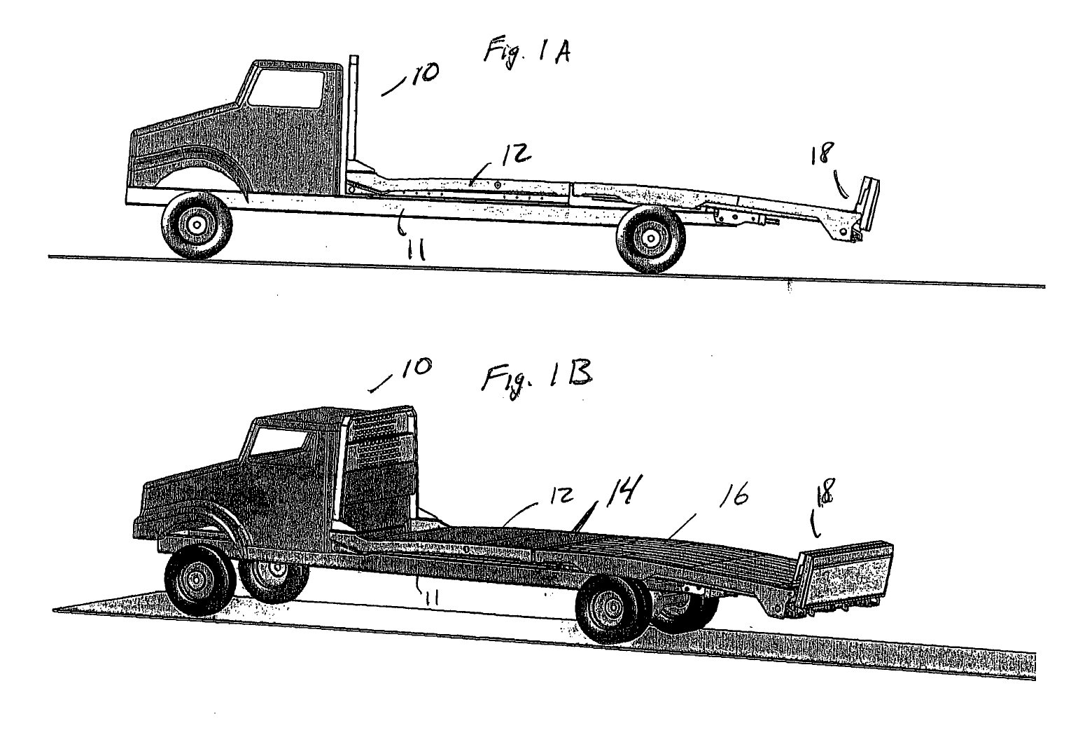

FIGS. 1A and 1B are directed to a first embodiment of the present invention and show truck 10 in the travel position (i.e. with the truck bed raised off the ground). At the end of truck bed 12 is a ramp 18. In FIGS. 1A-1B, ramp 18 is in a folded and upward position which is preferable for travel purposes. The first section 20 is hinged to the end of the truck bed. Folding the ramp so that it retracts to an upward position is advantageous as it reduces the overall length of the assembly.

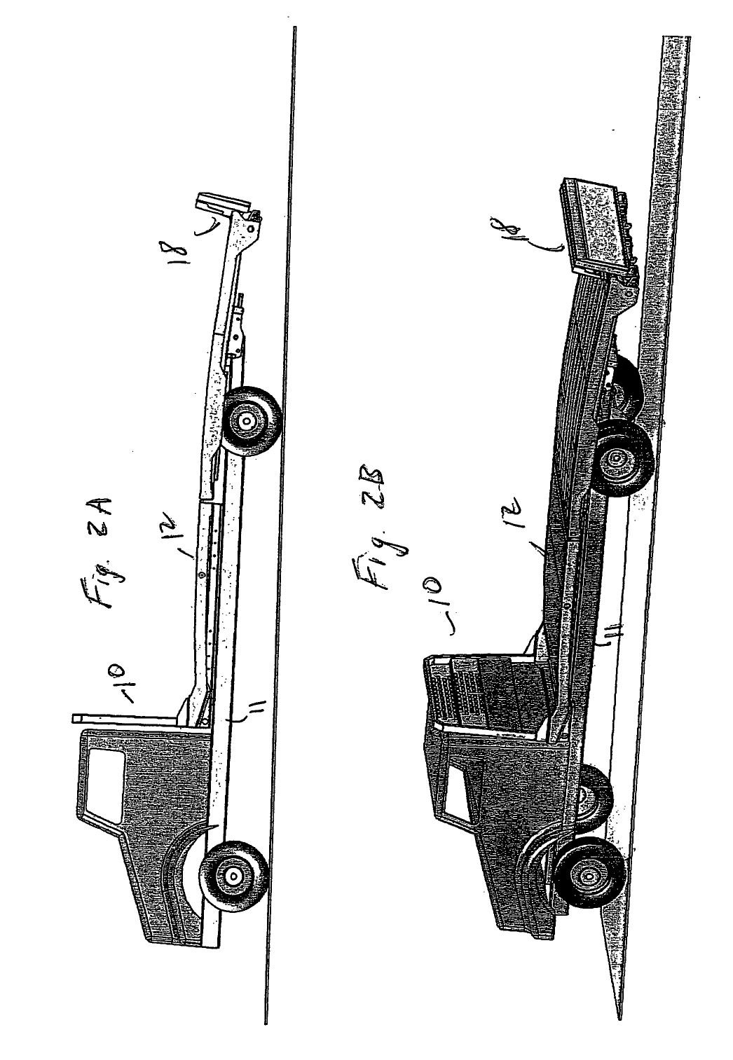

FIGS. 2A-2B show the truck 10 and ramp 18 of FIGS. 1A-1B, with the truck's air suspension lowered in order to bring the rear portion 16 of truck bed 12 closer to the ground. The truck bed 12 and ramp 18 are still in travel position.

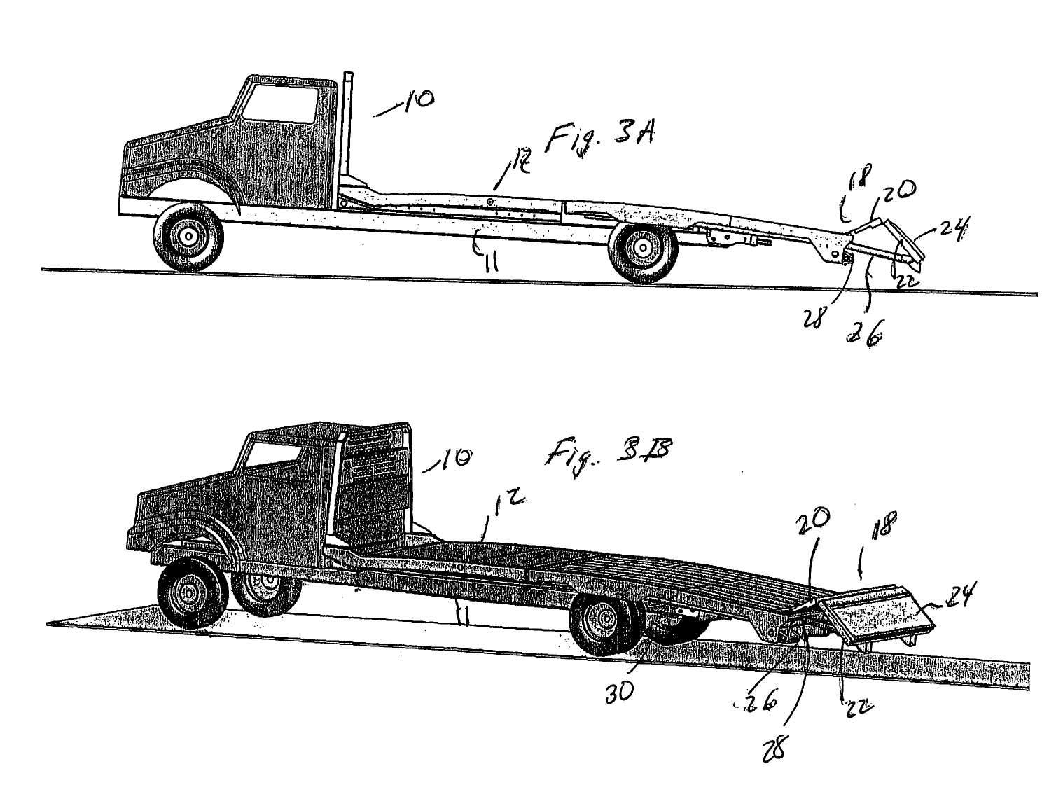

FIGS. 3A-3B show the truck 10 of FIGS. 2A-2B with the ramp 18 beginning to unfold. In this embodiment, ramp 18 is formed of three sections, a first section 20, a second section 22, and a third section 24. The second section 22 and the third section 24 are preferably both of equal width and are wider than the first section 20. This allows the connecting hinge of sections 22-24 to be positioned below the level of the truck bed 12 when the ramp 18 is in the folded position. The effect is to reduce the overall height of section 20 above the surface of the truck bed 12, thus reducing the overall wind drag encountered while driving. A ramp 18 of three sections allows a compact configuration when folded, and yet has enough length to form a full width, very low pitched access to the back portion of the lowered bed 12 when unfolded. As explained below, the present invention is not limited to three ramp sections. Ramp 18 can comprise two sections, or even one if wind drag is not considered to be a problem when the ramp is folded for travel. Alternatively, more than three sections can be used. Further, the invention is not limited to the widths described above.

In order to unfold ramp 18, an air operated, hydraulic, or electric actuator 30, for example, is activated by a control valve or switch to begin the extension of slide mechanism 26 outward through sockets 28 positioned near the rear of truck bed 12. The slide mechanism 26, sockets 28, and actuator 30 are preferably located under the truck bed 12 for protection but could be located elsewhere. In the preferred embodiment, slide mechanism 26 is hinge connected to the bottom end of second section 22 of ramp 18. With slide mechanism 26 partially extended, the lower end of second section 22 begins to separate from first section 20. It will be noted that preferably third section 24 remains folded and clamped to second section 22 during this portion of the unfolding phase.

In one embodiment of the present invention, slide mechanism 26 uses an air cylinder 30 throttled by a double rod end hydraulic cylinder with a flow control valve to control the speed of operation. Alternatively, the same design could be actuated by a number of different devices including a hydraulic cylinder, an air powered ball screw, or an electric ball screw.

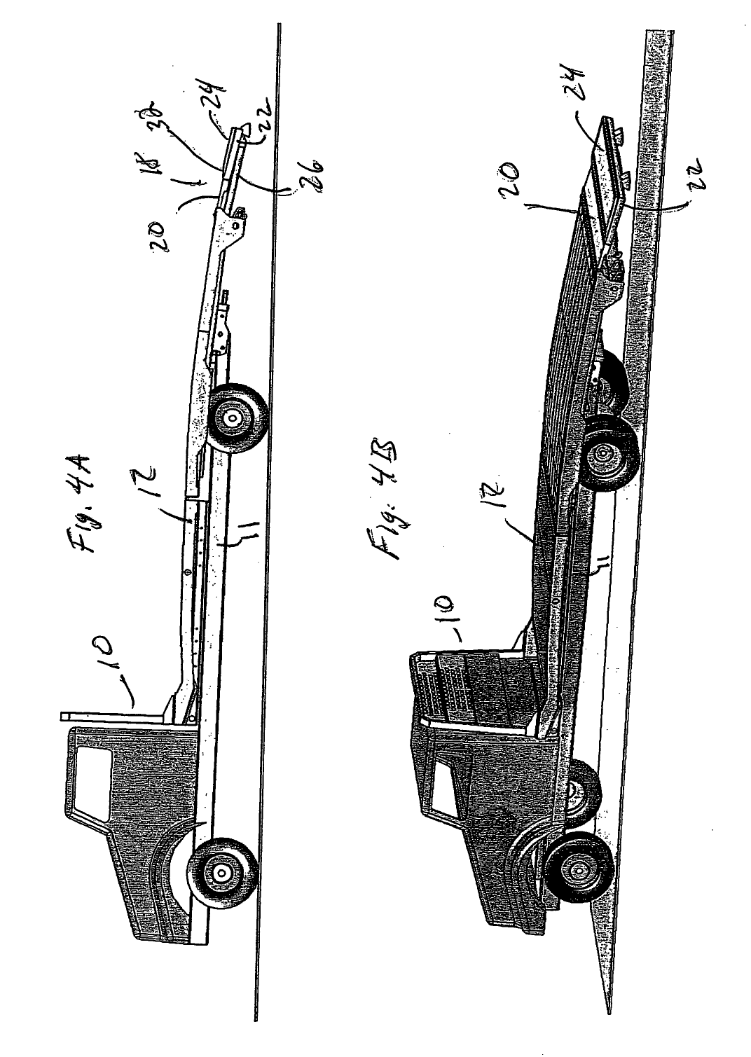

Once slide mechanism 26 has fully extended outward from sockets 28, the first section 20 and second section 22 of ramp 18 will be in a completely unfolded position, as shown in FIGS. 4A-4B. FIGS. 4A-4B continue to show the truck bed 12 in the travel position with the third section 24 still folded and clamped atop middle section 22.

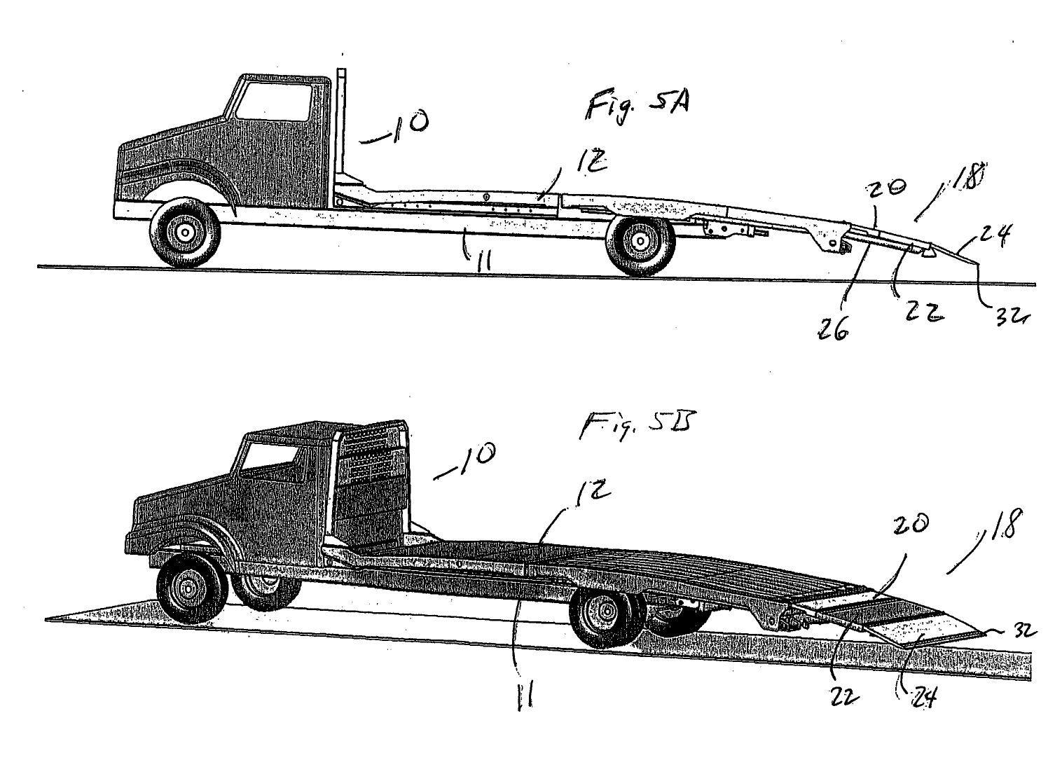

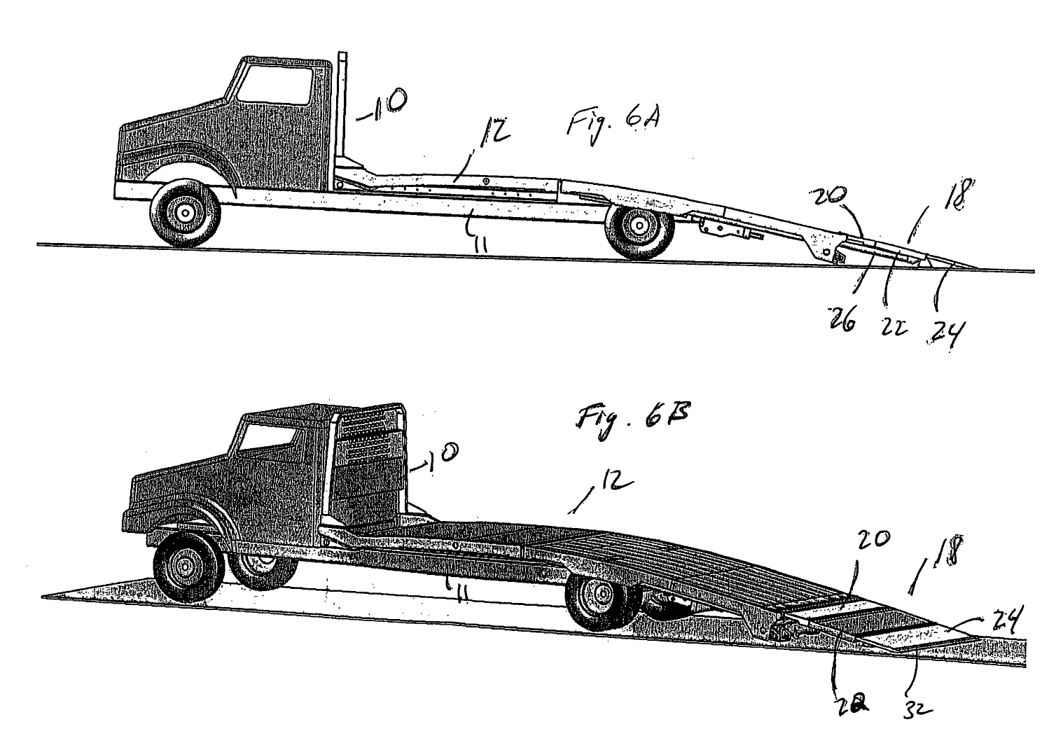

FIGS. 5A-5B continue to show the truck bed 12 in the travel position with third section 24 unclamped and unfolded from second section 22. Though this could be done after truck bed 12 has been lowered to the loading position, it is easier ergonomically to unfold it while in the travel position. Unfolding is preferably done manually. Preferably, third section 24 is well balanced by gas springs connected to second section 22 to reduce physical effort. Alternatively, a mechanism could be provided to power the unfolding of this section. It will be noted that the rear portion 32 of third section 24 is sloped so that the sloped section 32 will lie flat against the ground to provide a smooth incline for the ramp so that it will be easier for vehicles and equipment to be loaded and unloaded onto the ramp. FIGS. 6A-6B show the rear portion 16 of truck bed 12 in a lowered load/unload position with the first 20, second 22, and third 24 sections of the ramp 18 totally unfolded.

The ramp 18 can be folded following the above steps in opposite order. In particular, third section 24 would be folded on top of and clamped to second section 22 to prevent its opening during the retracting cycle. Slide mechanism 26 then would retract back through sockets 28 under truck bed 12. As slide mechanism 26 retracts, the second section 22 will fold up against first section 20 of ramp 18 until both sections are folded next to each other in an upward position as shown in FIGS. 1A-1B.

A ramp 18 of three sections allows a compact configuration when folded, and yet has enough length to form a full width very low pitched access to the back portion of the lowered bed 12 when unfolded. In a further embodiment of the invention, the ramp can comprise two sections (as explained below), or even one if wind drag is not considered to be a problem when the ramp is folded for travel.

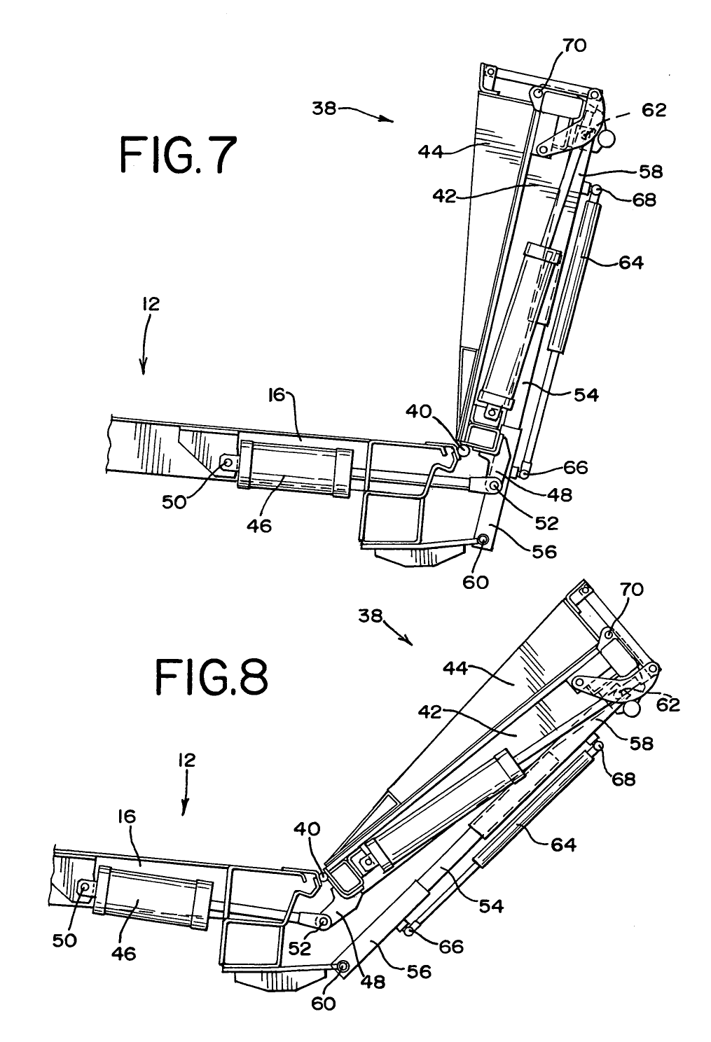

In a second embodiment of the present invention, as shown in FIG. 7, ramp 38 comprises two sections, a ramp front or first section 42 which is hinged to the rear portion 16 of truck bed 12 by a pin 40, and a ramp approach or second section 44 which is hinged to ramp front section 42 by a pin 70. Preferably, in this embodiment of ramp 38, ramp front section 42 and ramp approach section 44 either deploy or fold totally under power. Alternatively, a manual method or partially powered method could be used to deploy the ramp.

Deploying the ramp totally under power is preferably accomplished through the use of the following elements. A ramp column 54 includes two sections, a column slide 56 pinned to rear portion 16 of truck bed 12 at a pivot point 60, and a column sleeve 58 pinned to ramp front section 42 at a pivot point 62. A gas spring 64 pinned to column slide 56 at a ball socket 66 and to column sleeve 58 at a ball socket 68 provides force to extend ramp column 54, and serves to partially balance the weight of ramp 38. A cylinder 46 is attached to rear portion 16 of truck bed 12 at a pivot point 50, and to a bracket 48 (which is attached to ramp front section 42) at a pivot point 52. As stated above, the weight of ramp 38 is partially balanced by gas spring 64 providing force to extend ramp column 54, and is supported in its traveling position by air pressure to extend cylinder 46, thus pushing on bracket 48 through pivot point 52 and causing ramp front section 42 of ramp 38 to rotate counterclockwise around pin 40.

FIG. 8 shows a sectional view of ramp 38 of FIG. 7 of the second embodiment partially lowered. This is accomplished by introducing air pressure to the rod end of cylinder 46 to cause retraction, thus pulling on bracket 48 through pivot point 52 and causing ramp front section 42 of ramp 38 to rotate clockwise around pin 40. The action of lowering ramp 38 causes column slide 56 to retract into column sleeve 58 thus shortening ramp column 54 and compressing gas spring 64.

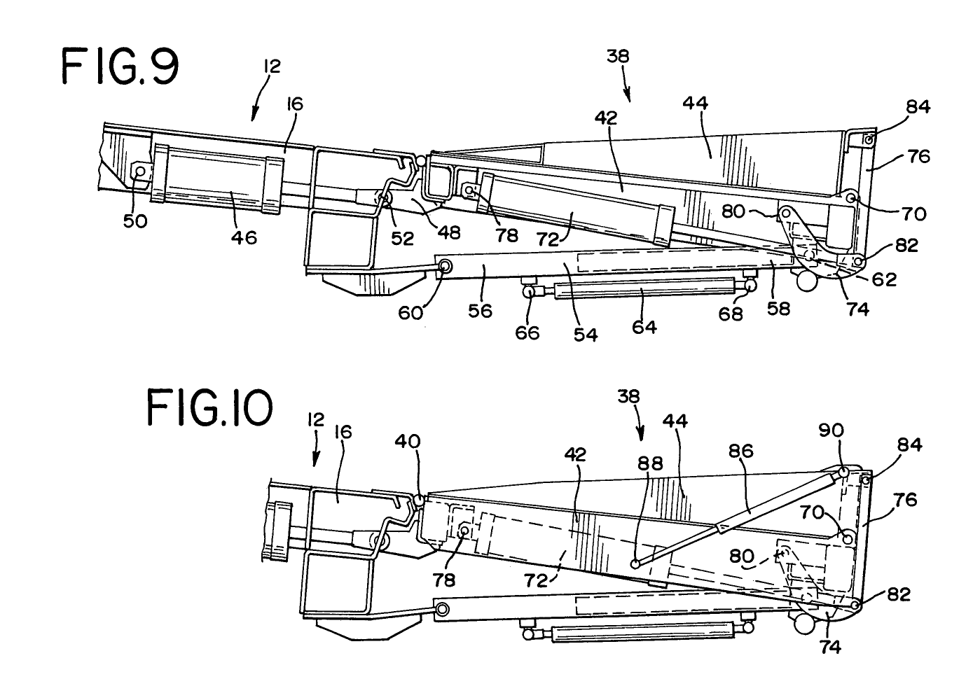

Supplying continuing pressure to the rod end of cylinder 46 will fully lower ramp 38 as shown in FIG. 9. In this sectional view of ramp 38, gas spring 64 is fully compressed, and ramp column 54 is fully retracted to form a solid support. In this position, ramp 38 can be used as an extension of rear portion 16 of truck bed 12 to carry an extended load, or to provide on/off access to loading docks since the bottom face of folded approach section 44 a well as the top is preferably finished with deck material. Alternatively, if so desired, only one face of folded approach section 44 may be finished with deck material. Power to unfold approach section 44 around a pin 70 is furnished by a cylinder 72, intermediate links 74, and a turning link 76. The blind end of cylinder 72 is attached to front ramp section 42 at a pivot point 78. Intermediate links 74 pivot on a pin 80, and join turning link 76 and the rod end of cylinder 72 at a pivot point 82. An intermediate link can be located on either side of the ramp or only on one side. The other end of turning link 76 is connected to approach ramp 44 at a pivot point 84.

In FIG. 10 (an end view of ramp 38), approach section 44 is partially balanced by a gas spring 86 which is pivotally connected to front ramp section 42 at a pivot 88, and to approach section 44 at a pivot 90. In cases where the approach section is extremely heavy, a duplicate gas spring may be mounted on the other end of ramp 38.

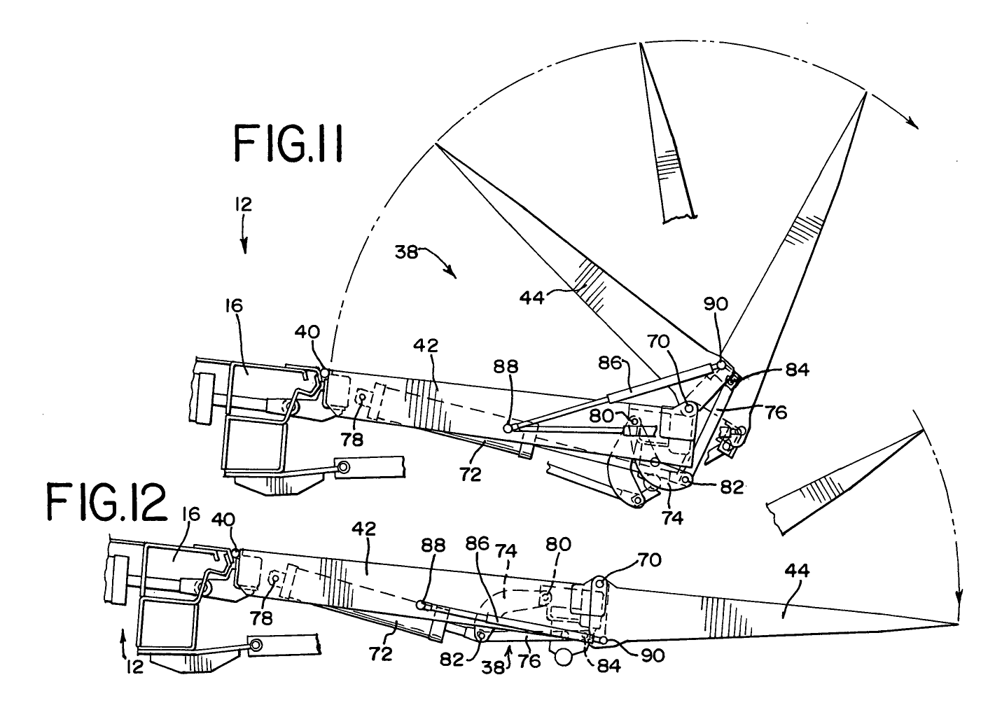

FIG. 11 shows an end view of ramp 38 with approach section 44 partially unfolded. This is accomplished by introducing sufficient air pressure to the rod end of cylinder 72 to begin retraction. Since the rod end of cylinder 72 is connected to pivot point 82, retraction simultaneously causes intermediate links 74 to rotate clockwise around pivot point 80, and turning link 76 to rotate approach section 44 clockwise about pin 70 due to its connection at pivot points 82 and 84. Gas spring(s) 86 assist in the unfolding process. One skilled in the art will clearly understand that gas spring(s) 86 extend until approach section 44 is nearly vertical. As unfolding proceeds beyond the vertical, gas springs 86 recompress to balance approach section 44 as it nears a horizontal attitude.

Supplying continuing pressure to the rod end of cylinder 72 will fully unfold ramp 38, as shown in FIG. 12. This side view of ramp 38 with approach section 44 completely unfolded is ready to be lowered to the ground for loading or unloading.

Ramp 38 can be folded by following the above steps in opposite order.

The following description is for illustrated purposes only and is not intended to limit the invention of this application.

We claim:

1. A ramp system connected to a base comprising:
a first ramp section;
a second ramp section having a front end and a back end, said front end being connected to said first section; and
a slide mechanism connected to said base and said back end of said second ramp section, said slide mechanism being extendable from and retractable into said base;
wherein in a folded configuration, said first ramp section is positioned substantially vertically and adjacent to said base, said second ramp section is positioned substantially vertically and adjacent to said base and almost all of said slide mechanism is located within said base,
wherein as said slide mechanism extends from said base, said back end of said second ramp section begins to separate from said first ramp section, and said first and second ramp sections begin to move to a substantially horizontal position, and
wherein when said slide mechanism is completely extended from said base, said first and second ramps are in a substantially horizontal position.

2. The ramp system of claim 1 further comprising a third ramp section connected to said back end of said second ramp section,
wherein in the folded configuration, said third ramp section is positioned vertically and adjacent to said second ramp section,
wherein as said slide mechanism extends from said base, said third ramp section begins to move to a substantially horizontal position while remaining adjacent to said second section, and
wherein after said slide mechanism is completely extended from said base and said first and second ramps are in a substantially horizontal position, said third ramp section can be flipped away from said second ramp section so that said third ramp section extends from said second ramp section and is in a substantially horizontal position.

3. The ramp system of claim 2 wherein said second and third ramp sections are of equal width and are wider than said first ramp section.

4. The ramp system of claim 1 wherein said slide mechanism is operated by a hydraulic or electric actuator.

5. The ramp system of claim 1 wherein said slide mechanism is activated by a control valve or switch.

6. The ramp system of claim 1 wherein said slide mechanism extends outward from sockets in said base.

7. The ramp system of claim 1 wherein said slide mechanism is hinge connected to said second ramp section.

8. The ramp system of claim 1 wherein said base is a trailer.

9. The ramp system of claim 1 wherein said base is a truck.

10. A ramp system connected to a base comprising:
a ramp section having a front end and a back end, said front end being connected to said base;
a ramp column comprising:
a column slide connected to said base;
a column sleeve connected to said back end of said ramp section; and
a spring connected to said column slide and said column sleeve; and
a cylinder connected to said base and said front end of said ramp section, said cylinder being extendable from and retractable into said base,
wherein in a folded configuration, said ramp section is positioned substantially vertically and said cylinder is fully extended from said base,
wherein as said cylinder retracts into said base, said ramp section begins to rotate toward a horizontal position, said column slide retracts into said column sleeve shortening said ramp column and compressing said spring, until said ramp column is fully retracted and said ramp section is in a substantially horizontal position.

11. The ramp system of claim 10 wherein one side of said ramp section is covered in deck material.

12. The ramp system of claim 10 further comprising a second ramp section having a front end and a back end, said front end of said second ramp section being connected to said back end of said ramp section;
wherein in a folded configuration, said second ramp section is positioned substantially vertically, forward of and adjacent to said ramp section,
wherein as said cylinder retracts into said base and said ramp section begins to rotate toward a horizontal position, said second ramp section also moves toward a horizontal position, until said ramp section and said second ramp section are in a substantially horizontal position, with said second ramp section on top of said ramp section.

13. The ramp system of claim 12 further comprising
a second cylinder connected to said front end of said ramp section and to a pin;
an intermediate link connected to said pin and said ramp section;
a turning link connected to said pin and said second ramp section; and
a second spring connected to said ramp section and said second ramp section,
wherein once said ramp section is in a substantially horizontal position with said second ramp section on top of said ramp section, said second cylinder can retract, causing said intermediate link and said turning link to rotate around said pin and said second spring to extend, causing said second ramp section to rotate upward and away from said ramp section, and then downward, causing said second spring to retract, until said second ramp section is in a substantially horizontal position extending from said back end of said ramp section.

14. The ramp system of claim 13 further comprising a second intermediate link, wherein one intermediate link is located on either side of said ramp section.

15. The ramp system of claim 13 further comprising a plurality of second springs, wherein one second spring is located on either side of said ramp sections.

16. The ramp system of claim 13 wherein said second spring is a gas spring

17. The ramp system of claim 12 wherein one side of said second ramp is covered in deck material.

18. The ramp system of claim 17 wherein another side of said second ramp is covered in deck material.

19. The ramp system of claim 10 wherein said base is a trailer.

20. The ramp system of claim 10 wherein said base is a truck.
